(19) United States
(12) Patent Application Publication
(10) Pub. No.: US 2026/0070567 A1
(43) Pub. Date: Mar. 12, 2026

(54) COMPUTER-IMPLEMENTED METHOD AND SYSTEM FOR PLANNING THE BEHAVIOR OF AN AT LEAST PARTIALLY AUTOMATED EGO VEHICLE

(71) Applicant: Robert Bosch GmbH, Stuttgart (DE)

(72) Inventors: Christian Heinzemann, Vellmar (DE); Heiko Freienstein, Weil Der Stadt (DE); Jens Oehlerking, Stuttgart (DE); Johannes Christian Mueller, Stuttgart (DE); Joram Berger, Heimsheim (DE); Martin Butz, Steinheim An Der Murr (DE); Martin Herrmann, Korntal (DE); Michael Rittel, Markgroeningen (DE); Ralf Kohlhaas, Calw (DE); Steffen Knoop, Hohenwettersbach (DE)

(21) Appl. No.: 19/244,125

(22) Filed: Jun. 20, 2025

(30) Foreign Application Priority Data
Jun. 21, 2024 (DE) 10 2024 205 800.9

(51) Int. Cl. B60W 50/00; B60W 60/00

(52) U.S. Cl. CPC B60W 50/0098; B60W 2050/0028; B60W 2050/0052; B60W 60/0013; B60W 60/0015; B60W 2555/60

(57) ABSTRACT

A computer-implemented method for planning the behavior of an at least partially automated EGO vehicle. The method uses a data basis of predefined partial situations and an evaluation model for each of these partial situations as well as a predefined set of rules for assessing possible behaviors of the EGO vehicle in a given situation. The method includes decomposing the given situation into a set of partial situations of the data basis and determining boundary conditions for the behavior of the EGO vehicle on the basis of the evaluation models of the identified partial situations. In doing so, a specified specialization hierarchy for the partial situations of the data basis is used.

### CROSS REFERENCE

The present application claims the benefit under 35 U.S.C. § 119 of German Patent Application No. DE 10 2024 205 800.9 filed on Jun. 21, 2024, which is expressly incorporated herein by reference in its entirety.

### FIELD

The present invention relates to a computer-implemented method and system for planning the behavior of an at least partially automated EGO vehicle.

A vehicle to which or for which the proposed behavior planning method is applied is referred to below as an EGO vehicle.

### BACKGROUND INFORMATION

The starting point of the present invention is a computer-implemented method for planning the behavior of an at least partially automated EGO vehicle by using a data basis of predefined partial situations and at least one evaluation model for each of these partial situations as well as a predefined set of rules for assessing possible behaviors of the EGO vehicle in a given situation. The EGO vehicle carries out at least the following method steps:
a. aggregating situation-specific information,
b. generating an environmental model of the given situation (30) on the basis of the situation-specific information,
c. analyzing the environmental model to identify at least one partial situation (61, 62) of the data basis (50) in the given situation,
d. generating at least one instance (71, 72, 73) for the identified partial situations (61, 62) by means of the situation-specific information,
e. analyzing all generated instances (71, 72, 73) by using the at least one evaluation model of the corresponding underlying partial situation (61, 62) to determine boundary conditions for the possible behaviors of the EGO vehicle (31) in the given situation (30),
f. prioritizing the possible behaviors of the EGO vehicle (31) on the basis of the thus determined boundary conditions in conjunction with the set of rules (100).

This method assumes that complex traffic situations can generally be decomposed into simpler sub-situations, which comprise only subareas of the overall situation, for example, or even only a selection of the road users of the overall situation. Often, the behavior decisions made for such sub-situations are also appropriate in the context of the overall situation.

The method provides that a given (traffic) situation is to be decomposed into predefined and analyzed partial situations in order to use the existing knowledge about the possible behaviors in the individual partial situations for the behavior planning in the given situation.

To this end, situation-specific information is first aggregated in order to generate an environmental model of the given situation. Advantageously, an object list is generated with all participants in the given traffic situation, i.e., with the EGO vehicle and any further road users. The decomposition of the given situation into partial situations is carried out by analyzing the environmental model. The identified partial situations are then instantiated by populating with the situation-specific information in order to specify the partial situations according to the given situation. The instantiated partial situations are analyzed independently of one another, wherein the evaluation models of the corresponding underlying partial situation are used. The analysis results for the individual instantiated partial situations are then merged in order to determine boundary conditions for the possible behaviors of the EGO vehicle in the given situation. It is essential that, at this stage of behavior planning, the method only provides for determining boundary conditions for the possible behaviors of the EGO vehicle. The detailing of one or more possible behaviors may take place at a later time. Prioritizing the possible behaviors of the EGO vehicle is also carried out on the basis of the thus determined boundary conditions. To this end, the boundary conditions for the individual behaviors are compared with the rules of the set of rules, i.e., it is checked which rules of the set of rules are observed by a behavior with the given boundary conditions and which rules are violated.

Such a method and a corresponding system for behavior planning are described in the German Patent Application No. DE 10 2022 214 267.

German Patent Application No. DE 10 2022 214 267 assumes that each partial situation defines a local condition that determines to which participants in the traffic situation and in which situation contexts it is to be applied. In particular, this condition must be formulated independently of other partial situations. In certain traffic situations, this may result in suboptimal behavior planning for the EGO vehicle since stricter boundary conditions than required for the behavior of the EGO vehicle are derived.

### SUMMARY

With the present invention, a development of the method described in German Patent Application No. DE 10 2022 214 267 is provided, which makes decomposing a present traffic situation into partial situations or their instantiation more efficient. This is because, through the measures according to the present invention, the instantiation of unnecessary partial situations can be dispensed with, without violating the safety guarantees of the method described in German Patent Application No. DE 10 2022 214 267. In some traffic situations, less restrictive but still safe boundary conditions for the behavior of the EGO vehicle can thus be derived and make higher performance of the EGO vehicle possible. In addition, the required computing time can be significantly reduced since less instantiated partial situations must be evaluated.

According to an example embodiment of the present invention, this is generally achieved by providing a specialization hierarchy for the partial situations of the data basis. A partial situation can be specialized by any number of other partial situations, which can in turn be specialized by further partial situations. What is important is that the specialization hierarchy does not contain any cycles, i.e., that the specialization hierarchy has a pure top-down structure.

By means of this specified specialization hierarchy, an order for the instantiation of the partial situations identified as part of the analysis of the environmental model is defined. This is because, according to the present invention, these partial situations are instantiated successively, starting with the at least one most specialized partial situation in the upward direction of the specialization hierarchy. However, according to the present invention, not necessarily all identified partial situations are instantiated. Instead, no further partial situation of the identified partial situations is instantiated at least when all objects of the given situation are already elements of a more specialized, already instantiated partial situation. That is to say, the instantiation is continued only until all objects of the given situation have been addressed. All remaining partial situations no longer need to be instantiated.

Accordingly, the instantiation according to the present invention of the identified partial situations starts with the most specialized partial situations, i.e., the partial situations that are not specialized in the specialization hierarchy by any further identified partial situation. For each of these partial situations, it is checked whether they are applicable to the present situation and whether their stored instantiation conditions are fulfilled. If yes, the partial situation is instantiated. In addition, the objects addressed by this partial situation are marked as “addressed” in the object list of the environmental model. For the identified partial situations of the next higher level of the specialization hierarchy, it is checked not only whether the partial situation is applicable to the present situation and whether its stored instantiation conditions are fulfilled, but also whether the objects that this partial situation addresses are already addressed by a more specialized partial situation. If these objects are marked as “addressed” in the object list, instantiation can be dispensed with. Otherwise, the partial situation is instantiated and the object list is updated accordingly. The method is then continued iteratively for the partial situations of the individual levels of the specialization hierarchy, but only until all objects of the given situation are marked as “addressed”. According to the present invention, the specialization hierarchy is thus used to avoid the instantiation of unnecessary partial situations to the greatest extent possible.

In one example embodiment of the present invention, the specialization hierarchy of the partial situations is represented as a tree structure in the system and is made accessible to the module performing the instantiation. In a further design variant, a directed acyclic graph can also be used at this point. For example, an explicit model of the tree or the implementation in an object-oriented class structure in which the specialization relationships are implemented via inheritance relationships can be selected as the form of representation.

For more efficient evaluation in the system, the partial situations can already be brought into an optimal evaluation order on the basis of the specialization hierarchy at design time so that the strategy according to the present invention for selecting the partial situations to be considered next in the instantiation process is already stored in the system at design time. Since the partial situation to be checked next thus no longer has to be ascertained in the system, the evaluation can be performed more efficiently.

The instances of the partial situations can be generated for the entire planning horizon or only for a time segment of the planning horizon of the behavior planning.

The situation that a partial situation will only remain relevant for a certain period of time in the future within the planning horizon of the automated vehicle or will only become relevant in the future can thus be taken into account. In this case, the marking “addressed” set by an instantiated partial situation would only apply for a particular time interval within the planning horizon of the vehicle. In this case, the more general partial situations would be instantiated for the time intervals that are not yet covered by the more specialized partial situations.

In principle, very differently defined partial situations and evaluation models implemented in different ways can be used within the scope of the present invention. Accordingly, there are also different possibilities for compiling the data basis of predefined partial situations and corresponding evaluation models.

In a preferred variant of the method according to the present invention, each partial situation is defined as a situation class determined at least partially by at least one of the following elements: the EGO vehicle, at least one traffic infrastructure element, at least one further road user, and a general situation context. The EGO vehicle and the at least one further road user are also referred to as objects of the given situation in the context of the present invention. This definition of a partial situation is explained in more detail in connection with FIG. 2. Such a partial situation is instantiable simply by populating with situation-specific information.

According to an example embodiment of the present invention, it is of particular advantage if the predefined partial situations of the data basis are selected such that an environmental model generated on the basis of situation-specific information can be represented by a composition of instantiated partial situations of the data basis. The data basis of the predefined partial situations should therefore preferably be compiled such that many different traffic situations, and in particular the most common traffic situations, can be completely decomposed into partial situations of the data basis. On the one hand, the partial situations should be so generic that they occur in as many different traffic situations as possible; on the other hand, they should also be so specific that the associated evaluation model has a certain validity.

A very effective method for analyzing traffic situations with the goal of determining boundary conditions for the behavior of an automated EGO vehicle in the particular traffic situation is the SOCA method, which is presented in the paper M. Butz et al., “SOCA: Domain Analysis for Highly Automated Driving Systems,” 2020 IEEE 23^{rd} International Conference on Intelligent Transportation Systems (ITSC), 2020, pp. 1-6, doi: 10.1109/ITSC45102.2020.9294438.

The SOCA method is used to analyze traffic situations with the goal of determining boundary conditions or requirements for the behavior of an automated EGO vehicle in the particular traffic situation. To this end, an abstract description of the traffic situation to be analyzed is created first. This description uses so-called zone graphs. A zone graph abstracts the traffic situation to be analyzed by representing the real road situation by means of a corresponding abstract traffic infrastructure element (static road geometry) with different zones that are relevant to the driving intention of the EGO vehicle but are initially specified neither in terms of their size nor in terms of their position. The different zones may represent different map regions, possible traffic flows, objects, etc. This abstract description of the traffic situation is then used to determine and morphologically analyze the possible developments or the behavior of the involved road users in order to determine boundary conditions for the behavior of the EGO vehicle in the analyzed traffic situation. It is worth noting that the results or boundary conditions obtained in this way initially apply to all traffic situations with the same zone graph. Specification does not take place until the results are populated with the situation-specific parameters of the analyzed traffic situation. The SOCA method is also suitable for generating evaluation models for the partial situations, which are then advantageously used within the scope of the method according to the present invention. In this case, the evaluation models are based on decomposing the particular partial situation into zone graphs and on morphologically analyzing the behavior of the involved road users. A particular advantage of the SOCA method is that formalized safety argumentations for the corresponding partial situations and also for their compositions can be derived from the evaluation models generated in this way.

According to an example embodiment of the present invention, in practice, some partial situations, or instances of partial situations, will interact and may even mutually exclude one another. These local interactions are advantageously already taken into account when merging the analysis results of the individual instantiated partial situations, if at least a portion of the evaluation models comprises combination rules for the combination of the particular partial situation with further partial situations.

Like the partial situations and the data basis of the partial situations, the set of rules used within the scope of the present invention can also be defined in very different ways. Since the set of rules is usually used to justify the safety of the behavior planning, the predefined set of rules comprises and prioritizes safety requirements and/or traffic rules in a preferred embodiment of the present invention. Furthermore, it may comprise and prioritize comfort requirements and/or technical vehicle boundary conditions.

As already mentioned above, within the scope of the method according to the present invention, each individual partial situation identified in the given situation, or each individual instance generated therefrom, is analyzed separately in order to determine the possible behaviors of the EGO vehicle for the particular instance. To this end, the boundary conditions that the EGO vehicle should fulfill in the particular instance are determined. These boundary conditions are referred to here as instance boundary conditions. The evaluation model and the situation context of the underlying partial situation are used to determine the corresponding instance boundary conditions, i.e., the evaluation model for the abstract partial situation is populated with the situation-specific information and thus specified for the particular instance.

According to an example embodiment of the present invention, it proves particularly advantageous if the boundary conditions for the possible behaviors of the EGO vehicle in the given situation can be determined by combining at least a portion of the generated instance boundary conditions. Such a combination will provide justifiable results at least when the given situation has been completely decomposed into partial situations, i.e., corresponds to the composition of the identified partial situations. Advantageously, any combination rules of the underlying evaluation models are already taken into account when combining the instance boundary conditions. In this way, the number of behaviors determined as possible can be reasonably limited even before the prioritization.

In a particularly advantageous variant of the method according to the present invention, the prioritization of the possible behaviors of the EGO vehicle provides a ranking of the possible behaviors, i.e., a prioritized list of possible behaviors. Such a list may be created simply by comparing the particular boundary conditions of each of the possible behaviors of the EGO vehicle with the rules of the set of rules. To this end, for each possible behavior defined by the corresponding boundary conditions, it is checked which rules of the set of rules are observed with these boundary conditions and which rules are violated. If the rules of the set of rules are appropriately defined, a sorting of the possible behaviors can thus be generated without the need for a separate metric.

According to an example embodiment of the present invention, it is of particular advantage, in particular for a safety argumentation with respect to behavior planning, if the comparison of the boundary conditions for the possible behaviors of the EGO vehicle with the rules of the set of rules is logged. In this case, the selection of a possible behavior for controlling the EGO vehicle is completely transparent and can be retraced at any time.

As mentioned above, the method according to the present invention only requires the determination of boundary conditions in order to define the possible behaviors of the EGO vehicle. The detailing of one or more possible behaviors may take place at a later time. The possible behaviors of the EGO vehicle in the given situation may also be defined by a set of behavior instructions that implement at least a portion of the determined boundary conditions, or by a reference trajectory that fulfills at least a portion of the determined boundary conditions. This variant is explained in more detail in connection with FIG. 7.

A particular advantage of the method according to the present invention is that a possible behavior of the EGO vehicle to be implemented in the given situation must not be detailed and/or optimized with respect to a specified quality function until after the prioritization of the behaviors previously determined as possible. This contributes to significant savings in the computing effort for the behavior planning and control of the EGO vehicle.

### BRIEF DESCRIPTION OF THE DRAWINGS

FIG. 1 shows a block diagram with a computer-implemented system according to an example embodiment of the present invention for planning the behavior of an at least partially automated EGO vehicle.

FIG. 2 illustrates the concept of a partial situation within the scope of a computer-implemented behavior planning method according to an example embodiment of the present invention.

FIG. 3 illustrates the identification of partial situations in an example situation according to one example embodiment of the method according to the present invention.

FIG. 4 illustrates the instantiation of the partial situations identified in the example situation.

FIG. 5 illustrates the analysis of the thus generated instances and the determination of instance boundary conditions for the possible behaviors of the EGO vehicle in the individual instances of the partial situations.

FIG. 6 illustrates the combination of the instance boundary conditions for determining boundary conditions for the possible behaviors of the EGO vehicle in the example situation.

FIG. 7 illustrates the use of the thus determined boundary conditions for trajectory proposals for the EGO vehicle in the example situation.

FIG. 8 illustrates a priority synthesis for the example situation according to the method according to the present invention.

FIG. 9 illustrates the use of a specialization hierarchy of partial situations within the scope of the method according to the present invention.

### DETAILED DESCRIPTION OF EXAMPLE EMBODIMENTS

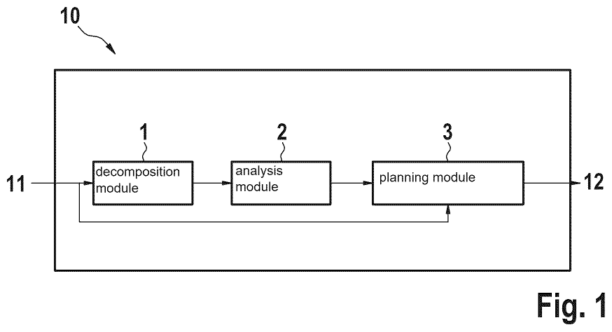

The block diagram in FIG. 1 illustrates the functional principle of a computer-implemented system according to the present invention for planning the behavior of an at least partially automated EGO vehicle.

The system according to the present invention comprises a perception module for aggregating situation-specific information from on-board and off-board information sources, not shown separately here, as well as an evaluation module for generating an environmental model 11 of the given situation on the basis of the situation-specific information, which is also not shown Separately here.

An essential component of the system according to the present invention is a decomposition module 1, which analyzes the environmental model 11 of a given situation. The decomposition module 1 has access to a data basis in which predefined partial situations are stored together with a specialization hierarchy for the partial situations as well as at least one evaluation model for each of these partial situations. This data basis, as a functional component of the decomposition module 1, is not shown separately here. By means of the decomposition module 1, a given situation is decomposed into partial situations. To this end, the environmental model 11 of the given situation is analyzed in order to identify at least one partial situation of the data basis in the given situation. In addition, the decomposition module 1 identifies the instances of the identified partial situations that are relevant to the given situation and generates these instances by populating the corresponding partial situations with situation-specific information. According to the present invention, the specialization hierarchy of the partial situations is used for this purpose. That is to say, the specialization hierarchy is used to define an order for a successive instantiation of the identified partial situations. First, the most specialized partial situations are instantiated. In the subsequent instantiation steps, the partial situations of the next higher hierarchy level are then instantiated in each case. According to the present invention, this instantiation process is continued only until all objects of the given situation are processed in an instantiated partial situation.

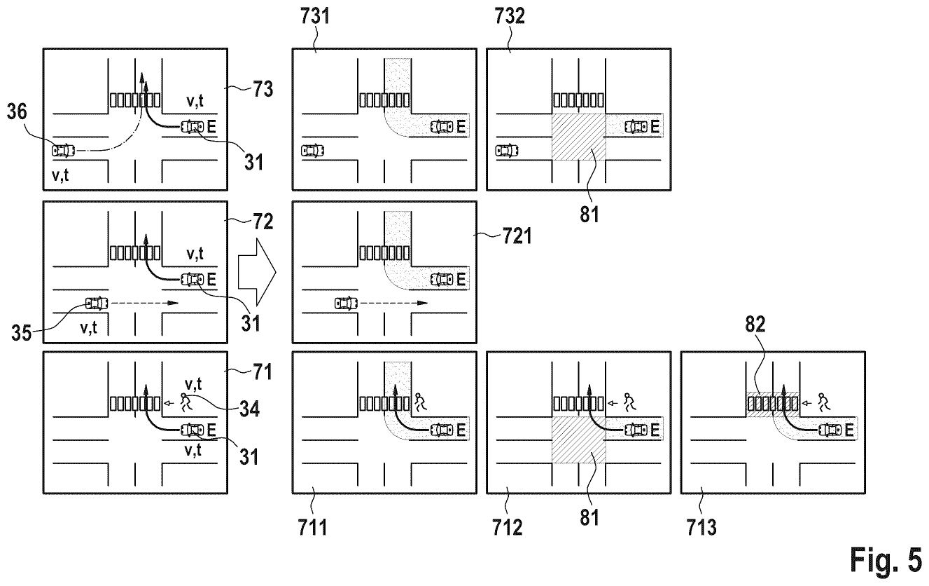

As a further essential component, the system according to the present invention comprises an analysis module 2 for determining boundary conditions for possible behaviors of the EGO vehicle in the given situation. To this end, the analysis module 2 analyzes all generated instances by using the at least one evaluation model of the corresponding underlying partial situation. The analysis module 2 merges the results of these “individual” analyses and assesses the overall result by means of a predefined set of rules. In this way, the analysis module 2 performs a so-called priority synthesis, which is explained in more detail below in connection with FIGS. 5, 6, and 8. This priority synthesis has the goal of generating a prioritized list of the possible behaviors for the EGO vehicle in the given situation.

This list is fed to a downstream planning module 3, which can then select one or more behaviors from the prioritized list for controlling the EGO vehicle. If these behaviors are initially only defined by boundary conditions, the planning module 3 must detail the selected behaviors for the control, for example in the form of trajectories 12.

The system 10 shown in FIG. 1 thus consists of three components:

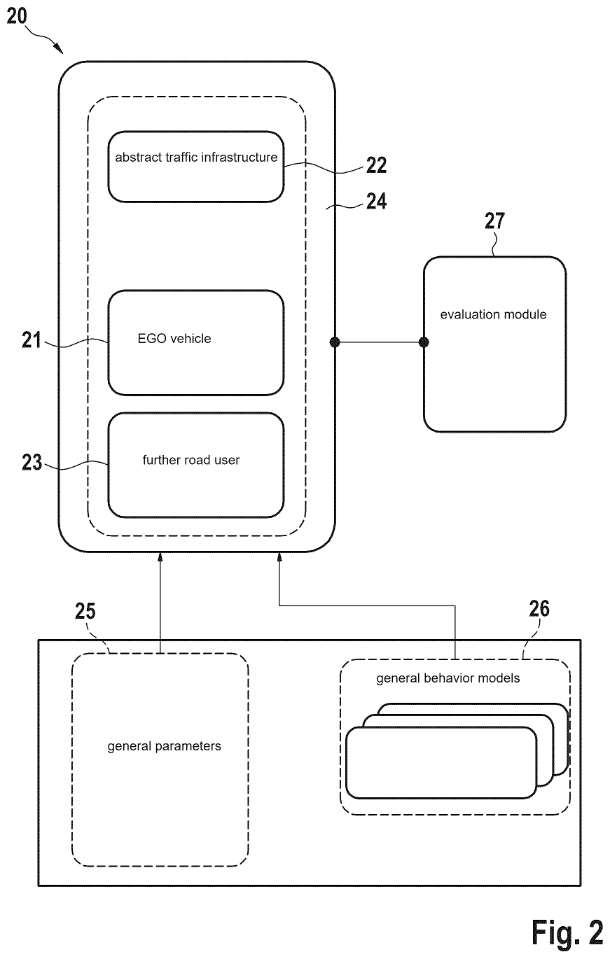

On the basis of the environmental model 11, the decomposition module 1 traces the current traffic situation back to a composition of a finite set of simpler situations, the so-called partial situations. The structure and function of a partial situation are explained in more detail below in connection with FIG. 2. According to the present invention, these partial situations are preanalyzed individually and in composition offline, for example by means of the SOCA approach, in order to generate evaluation models, which the analysis module 2 can then access online. On the basis of these evaluation models, a general safety argumentation for the partial situations and their compositions can be derived and formalized in a set of rules. It can thus be formally guaranteed that the vehicle will behave in the way that is most beneficial to the situation perceived by the vehicle.

The analysis module 2 derives a set of possible behaviors from the composition of the partial situations. A possible behavior may, for example, be represented by a set of boundary conditions, a set of behavior instructions, or a reference trajectory. For priority synthesis, the analysis module 2 analyzes the possible behaviors with respect to the partial situations. To this end, the analysis module 2 uses the pregenerated evaluation models of the individual partial situations. The possible behaviors are then prioritized on the basis of the analysis results in combination with the set of rules. The prioritization of the possible behaviors of the vehicle is carried out in an automated manner and is performed dynamically at runtime. In addition, prioritization allows efficient allocation of computing resources.

This is because the planning module 3 usually selects only one or even multiple prioritized behaviors in order to detail and optimize them. In addition, the planning module 3 checks whether the detailed solution fulfills all boundary conditions required of it. The planning module 3 generally selects the possible behavior that fulfills all boundary conditions and has the highest priority as the solution. If multiple behaviors have the same priority, the solution that is best with respect to an optimality criterion is output.

If possible, this enforces safer behavior while meeting all boundary conditions. Even if it is no longer possible to meet all boundary conditions, it is still possible to provide a solution that least violates the applicable boundary conditions. These boundary conditions may be strict, such as “stop in front of the traffic light”, but also comparatively lenient, such as “drive past the obstacle rather than stop”. Explicating the boundary conditions, both those that could be met and those that were not met, makes it possible to retrace and justify a driving decision made.

In one embodiment of the present invention, the planning module uses a graph search (e.g., hybrid A* algorithm) to detail a behavior represented as a set of boundary conditions and to optimize the found solution with respect to a quality function. The solution is checked for meeting all boundary conditions in order to verify the validity of the solution. The planning module then outputs a trajectory corresponding to the highest-priority behavior that is valid. If there are multiple behaviors of the same priority, the trajectory that is optimal with respect to the quality function is output.

It is expressly pointed out at this point that the architecture of the system 10 shown in FIG. 1 and its components can be varied. For example, the possible behaviors of the EGO vehicle may alternatively also be provided by the planning module or a specialized generator module. In addition, it is also possible to provide a separate module for each of the individual method steps or to combine the decomposition and the priority synthesis into a single module.

FIG. 2 illustrates the concept of a partial situation and its use within the scope of the present invention. The present partial situation is a situation class, which is abstractly described by certain properties or elements. The description of the partial situation 20 illustrated here comprises essentially three elements: the EGO vehicle 21, an abstract traffic infrastructure element 22, and a further road user 23. Each of these three elements is characterized by models, rules, state parameters, and/or state variables. For example, the EGO vehicle is characterized here by its driving intention, dynamic state variables, such as velocity, acceleration and orientation, system parameters, such as technical vehicle parameters, and a behavior model, such as defensive driving or sports driving. For example, the abstract traffic infrastructure element 22 could be an intersection, a junction, or a road section. It is characterized here by a zone graph according to the SOCA method and by the traffic rules applicable to this traffic infrastructure element, i.e., for example, “priority to the right”. The further road user 23 is also characterized here by its “movement” intention and by dynamic state variables, as well as by a behavior model with which assumptions for the behavior of the further road user can be made. The elements 21, 22, and 23 are embedded in a general situation context 24, in which both general parameters 25 and general behavior models 26 of road users are incorporated. By way of example, road condition parameters, weather parameters, and light parameters are mentioned as general context parameters here. The general behavior models 26 could include motion models for classes of road users, such as pedestrians, cyclists, motorcyclists, car drivers, etc., and may model interactions between road users. For example, the behavior models may be modeled by continuous motion models in the form of differential equations, by Markov decision processes, or by discrete decision spaces.

A partial situation 20 defined in this way can be instantiated by populating with situation-specific information, i.e., can be configured according to a given situation.

In one embodiment of the present invention, the motion models for describing the other road users are divided into different categories, for example into the three categories of uncooperative, expected, and cooperative behavior. First, the expected behavior is assumed for all road users except for the EGO vehicle. The output of a multi-trajectory prediction network as described in [Strohbeck et al. (2020)] may, for example, be used to predict the expected behavior. Due to the multimodality of the prediction, this spans combinatorics of possibilities, which can, however, already be thinned out sharply by means of a dependence tree of the road users. Such a dependence tree represents the dependence relationships of the road users, for example on the basis of physical dependencies, traffic rules, or on the basis of heuristics. A possible behavior for the road user who is at the beginning of the dependence chain along a dependence graph, i.e., on whom the other road users depend, is thus selected first. For all subsequent road users, only behaviors that are permitted under the condition of the behaviors of the road users who are ahead in the dependence chain are then permitted.

In addition to the expected behaviors, the uncooperative behavior is also investigated for the road users on whom the EGO vehicle depends. Accordingly, behaviors of the EGO vehicle that are safe even when assuming uncooperative behavior of road users having the right of way are prioritized, and behaviors that are safe only in the case of expected behavior are already used as the first fallback level. Behaviors that require cooperative behavior of vehicles having the right of way serve as a further fallback level. However, such behaviors are only used in emergencies.

On the other hand, for road users who must grant the EGO vehicle the right of way, a cooperative behavior model is additionally used. The expected behavior is compared to the cooperative behavior. If they are consistent, cooperative behavior is assumed for the dependent vehicles so that they can be ignored. However, if inconsistencies between the expected and the cooperative behavior model make it likely that a subordinated road user will not obey the traffic rules and thus may become dangerous to the EGO vehicle, behaviors of the EGO vehicle that are still safe, taking into account a corresponding violation of the rules or assuming an uncooperative model with respect to this road user, will be given a higher priority.

The partial situation 20 was analyzed by means of the SOCA method. An evaluation model 27 that can be used as the basis for the analysis of all instances of the partial situation 20, for example in the form of Zwicky boxes, was thus generated. The correspondingly populated evaluation model 27 then provides instance boundary conditions for possible behaviors of the EGO vehicle in the particular instance.

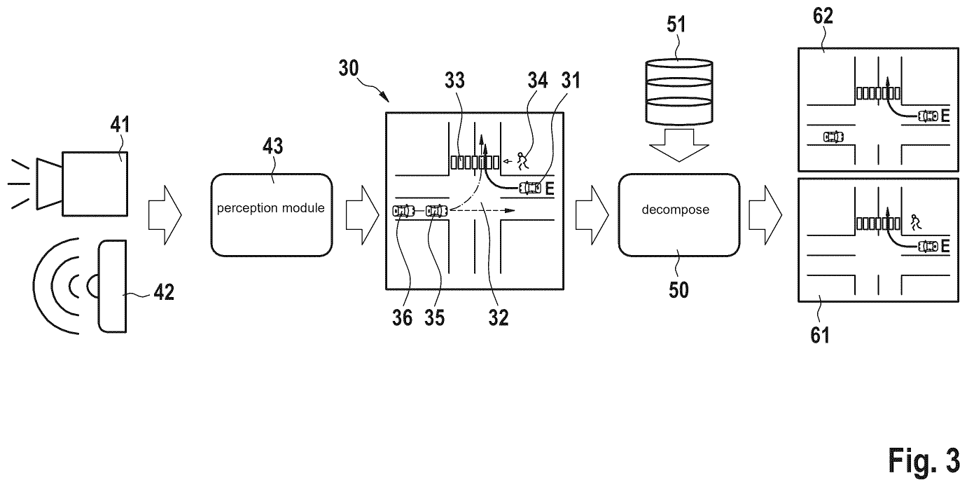

FIG. 3 illustrates the decomposition according to the present invention of an example situation 30 into partial situations.

In the example situation 30, the EGO vehicle 31 is approaching the intersection area 32 of an intersection from the right or east with the driving intention of turning right, i.e., north. To this end, the EGO vehicle 31 must traverse a pedestrian crossing with zebra stripes 33 on the roadway leading north. A pedestrian 34 is approaching the zebra stripes 33 from the east with the intention of crossing the roadway. In addition, two further vehicles 35 and 36 are approaching the intersection area 32 from the west. The two vehicles 35 and 36 drive on the same roadway one after the other so that the vehicle 35 reaches the intersection area 32 earlier. Vehicle 35 intends to traverse the intersection in an eastward direction, i.e., to drive straight ahead, while vehicle 36 intends to turn left, i.e., north.

The EGO vehicle 31 has vehicle sensors 41 for acquiring situation-specific information. The vehicle sensors 41 could, for example, include video, radar, and/or LIDAR sensors and possibly also inertial sensors. Furthermore, the EGO vehicle 31 also has access to off-board information sources 42, such as GPS data, data from infrastructure sensors, or weather and road condition data, traffic information, etc. In a perception module 43, all of this situation-specific data is merged into an environmental model of the example situation 30. In doing so, an object list with all participants in the given traffic situation is also created.

For decomposing 50 the example situation 30 into partial situations, the environmental model is first analyzed in order to identify at least one of the predefined partial situations, which are stored in a database 51, in the example situation. To this end, the EGO vehicle 31 is first located on a map in order to extract the infrastructure elements that surround the EGO vehicle 31, here the intersection with the intersection area 32. This map could be a standard-definition (SD) map, as used in the context of navigation systems, or a high-definition (HD) map, which has higher accuracy and is preferably used in conjunction with automated driving functions. Information, such as the traffic rules taken from the map, the current weather situation, e.g., normal, heavy rain, fog, danger of ice, etc., which can be obtained via vehicle perception or from the Internet, as well as general models describing the movement of road users form the situation context. On the basis of this information, it is decided at the runtime of the system how many instances of which partial situations are present. In the present example situation, the partial situation 61 “pedestrian at pedestrian crossing” is present once, while the partial situation 62 “further vehicle is approaching the intersection area from the west” is present twice. The instantiation conditions are stored together with the corresponding partial situation in the database 51, either as program code that makes corresponding evaluations, or as a model of the instantiation condition, which model can include, for example, geometric operations, graph structures, or also predictions of other road users. In general, instantiation conditions model properties of elements and/or combinations of elements of the situation context that must be given in a partial situation.

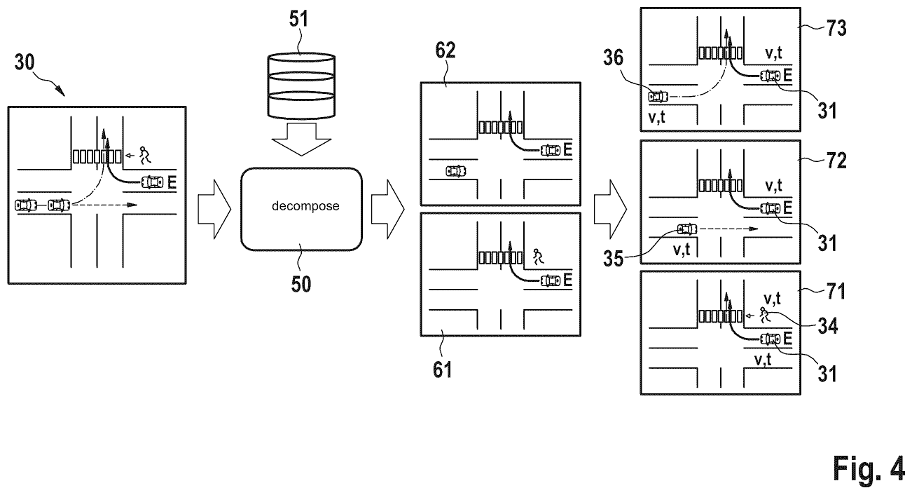

FIG. 4 illustrates the instantiation of the partial situations 61 and 62 identified in the example situation 30. For instantiating the partial situations 61 and 62, the template-like partial situations stored abstractly in the database 51 are populated with the present situation-specific data of the example situation 30 and are thus specified according to the example situation 30. In the case of the partial situation 61 “pedestrian at pedestrian crossing”, this populating includes in addition to situation-specific information on the EGO vehicle 31, on the traffic infrastructure element 32 and on the general situation context, in particular situation-specific information on the pedestrian 34, such as position, speed, walking direction, etc. Further road users are not taken into account in the partial situation 61 and, consequently, also not in the instance 71 of this partial situation 61. In the case of the partial situation 62 “further vehicle is approaching the intersection area from the west”, an instantiation 72 for the vehicle 35 and a further instantiation 73 for the vehicle 36 are carried out. During the populating of the partial situation 62, these instantiations 72 and 73 also take into account only the EGO vehicle 31 and the one further vehicle 35 and 36, respectively, but not any further road users.

FIG. 5 illustrates the analysis of the resulting instances 71, 72, and 73, as well as the determination of instance boundary conditions for the possible behaviors of the EGO vehicle 31 in the individual instances 71 as well as 72 and 73 of the partial situations 61 and 62.

All generated instances 71, 72, and 73 are evaluated individually and independently of one another, namely, by using an evaluation model that has been pregenerated for each partial situation 61 and 62 and is also stored together with the corresponding partial situation in the database 50. For the evaluation or analysis of the individual instances, information from the situation context relevant to the particular partial situation is used again. For example, for the partial situation 61 “pedestrian at pedestrian crossing”, the position of the pedestrian within the partial situation, i.e., for example, on or in front of the crossing, is relevant since it can affect the planning decision. The evaluation models of the particular partial situations then provide a set of permitted behaviors for the EGO vehicle 31 with respect to their own situation context and without consideration of other partial situations.

In the exemplary embodiment described here, the evaluation models of the individual partial situations are based on the SOCA method. Accordingly, conflict areas between the two road users of the particular instances are described by Zwicky boxes in the traffic infrastructure element. The individual conflicts can be assessed by means of a conflict severity.

In the case of the single instance 71 of the partial situation 61 “pedestrian at pedestrian crossing”, the presence and the location of a conflict area depend on the position and velocity of the EGO vehicle 31 and on the position and velocity of the pedestrian 34 at the time of detection t. In a first case constellation 711, the pedestrian 34 is so slow that the EGO vehicle 31 can still turn without endangering the pedestrian 34. In a second case constellation 712, the EGO vehicle 31 should not enter the intersection area, i.e., conflict area 81, but should stop at the stop line. And, in a third case constellation 713, the EGO vehicle 31 can enter the intersection area but should then stop in front of the zebra stripes 33, i.e., conflict area 82. The differentiation between these different constellations is described in the SOCA method via a Zwicky box and formally modeled.

In the case of the instance 72 “straight-ahead driver” of the partial situation 62 “further vehicle is approaching the intersection area from the west”, there is only one case constellation 721. In this case constellation, there is no conflict between the further vehicle 35 and the EGO vehicle 31.

In the case of the instance 73 “left turner” of the partial situation 62 “further vehicle is approaching the intersection area from the west”, there are two case constellations 731 and 732. In the first case constellation 731, the further vehicle 36 is so slow that the EGO vehicle 31 can still safely turn right in front of the left-turning vehicle 36. In the second case constellation 732, the EGO vehicle 31 should not enter the intersection area, i.e., conflict area 81, but should stop at the stop line even if it has the right of way over the left-turning vehicle 36 since the vehicle 36 has already initiated the turning process.

Sets of instance boundary conditions for the possible behaviors of the EGO vehicle in the corresponding instances can be derived from the Zwicky boxes 81, 82. These instance boundary conditions are each based on the question: “What can happen and what is the consequence?”

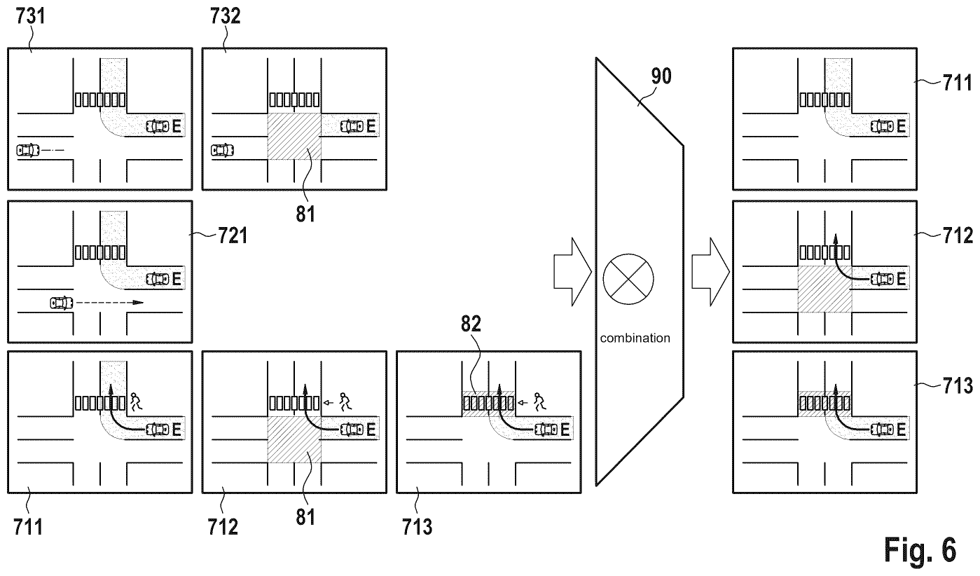

FIG. 6 illustrates the combination of the instance boundary conditions for determining boundary conditions for the possible behaviors of the EGO vehicle 31 in the example situation 30.

In the exemplary embodiment described here, the combination 90 of the ascertained instance boundary conditions simply consists in merging the instance boundary conditions. However, the combinations of the instance boundary conditions and thus of the possible behaviors of the EGO vehicle 31 could also be thinned out, for example by heuristics and rules that are already created in the evaluation models of the individual partial situations. In the present case, the possible behaviors 711=721=731; 712=732; and 713 remain.

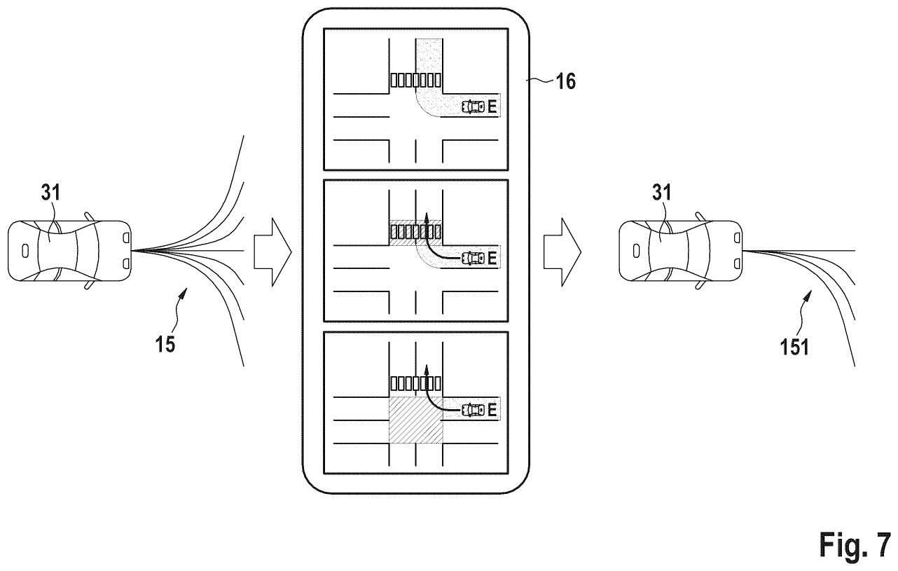

As noted above, the possible behaviors of an EGO vehicle in a given situation can be described in different ways. For the prioritization according to the present invention, the possible behaviors are sufficiently determined by the boundary conditions ascertained by combining the instance boundary conditions. Detailing the behaviors may also be carried out after the prioritization. It is also conceivable, however, that trajectory candidates 15 that have already been sampled are present. In this case, the ascertained boundary conditions for the possible behaviors of the EGO vehicle 31 can be used as filters 16, which is illustrated in FIG. 7. Accordingly, the trajectory candidates 15 are compared with the ascertained boundary conditions. In doing so, trajectory candidates that are not compatible with the boundary conditions are eliminated. The result is an unsorted list of appropriate trajectory candidates 151.

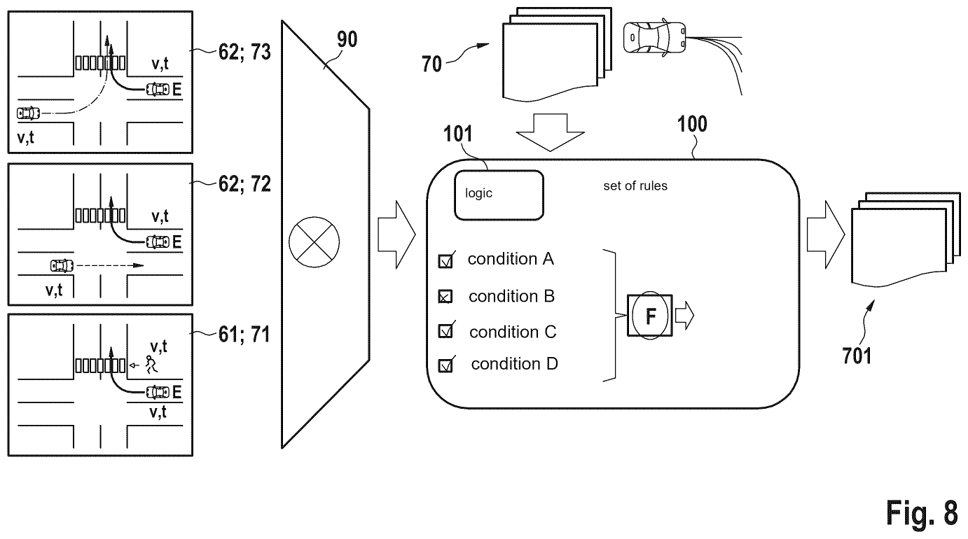

FIG. 8 illustrates a priority synthesis for the example situation 30 according to the method according to the present invention.

As already explained above in connection with FIGS. 5 and 6, as part of the priority synthesis, the possible behaviors of the road users who are relevant to the driving decision of the EGO vehicle are determined first by means of partial situations 61; 62 and their instantiation 71; 72, 73. The combination 90 of these behaviors is thinned out by corresponding heuristics. Thereafter, the priority synthesis evaluates the composition of the partial situations and defines the priority order by means of a predefined set of rules 100. The set of rules could advantageously use the same rules as the SOCA analysis of the partial situations in order to support the safety argumentation of the driving function. Some examples of such rules are listed below:
In crossing situations, boundary conditions from partial situations with pedestrians at the zebra stripes are prioritized higher than boundary conditions from partial situations with oncoming vehicles, which would have to turn left for a conflict.
Boundary conditions from instances of partial situations that do not lead to conflicts with the EGO vehicle can be ignored, e.g., pedestrians waiting at the zebra stripes, oncoming vehicle driving straight through.
Special situation: oncoming vehicle turns and violates the traffic rules in the process
   Case 1: no pedestrian on the zebra stripes→behavior that stops and waives the right of way has the highest priority
   Case 2: pedestrians on the zebra stripes→behavior that enters the intersection but stops in front of the zebra stripes has priority. The EGO vehicle thus forms a buffer zone for the pedestrian and accepts vehicle body damage in order to protect the life of the pedestrian. Since the EGO vehicle has the right of way, the turning vehicle is legally wrong.

For comparing the ascertained boundary conditions for the possible behaviors of the EGO vehicle 31 with the rules of the set of rules 100, the set of rules 100 has a logic 101 and a comparison function F, which brings the individual, initially unsorted behaviors 70 into a prioritized order 701. The basic assumption for the sorting is that the planning module must select behaviors that are allowed in all instances of partial situations that are present at the time of detection. Conflicts, e.g., conflicting requirements of different partial situations, are resolved by means of the set of rules 100 so that unambiguous ranking 701 results. Finally, the priority synthesis module passes the generated behavior options of the EGO vehicle in a prioritized manner to a planning module, see FIG. 1 in this respect.

Overall, for the above-described exemplary embodiment, the set of rules 100 results in a prioritization that is, for example, based on a safety argumentation for the automated driving function that was derived via the SOCA methodology. The set of rules 100 may define exceptions for specific compositions of partial situations for the basic relationships described above. In addition, an absolute order of the behaviors of the EGO vehicle is established on the basis of this set of rules and the evaluation of the different partial situations and the associated combinatorics of behaviors. On the basis of this order, the set of possible behaviors are sorted and transferred to the planning module.

Automated vehicles must be able to find their way in complex situations that may change quickly and unexpectedly. Thus, despite the utmost care, an automated vehicle may end up in a situation from which it can no longer extricate itself while meeting all specified boundary conditions. In addition, situations may also arise in which requirements and boundary conditions contradict one another. In literature, this is known as the falling crane problem [R. Benenson, T. Fraichard, M. Parent (2008)] and variants thereof. The method according to the present invention offers the possibility of prioritizing a set of possible behaviors of an automated vehicle in such a way that the automated vehicle, whenever possible, drives particularly efficiently and comfortably, while, in the event of unexpected developments in a situation or in the case of unfulfillable or contradictory requirements and boundary conditions, it may fall back on less preferred but still safe solutions, which can however be retraced and justified in any case.

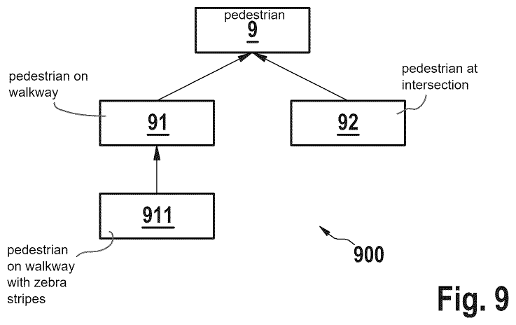

FIG. 9 illustrates the use of a specialization hierarchy of partial situations within the scope of the method according to the present invention.

As already mentioned, the present invention provides that, together with a data basis of predefined partial situations, a specialization hierarchy for the partial situations of the data basis is also provided. The partial situations identified as part of the analysis of the environmental model of a given situation can thus be classified according to this specialization hierarchy or brought into a corresponding order. This is explained in more detail below in connection with FIG. 9 using the example of a pedestrian in a given situation.

In the present example, the behavior of an EGO vehicle is to be planned in a traffic situation with a pedestrian, wherein the pedestrian is on a walkway without zebra stripes and outside an intersection area.

During the analysis of the environmental model of this traffic situation, four partial situations 9, 91, 92, and 911 that address a pedestrian in the surroundings of the EGO vehicle were identified. FIG. 9 shows a tree structure 900 representing the specialization hierarchy of these partial situations 9, 91, 92, and 911. The most general partial situation 9 “pedestrian” addresses a pedestrian in the surroundings of the automated vehicle without considering further context. The partial situation 9 “pedestrian” is specialized by two partial situations 91 “pedestrian on walkway” and 92 “pedestrian at intersection”. The partial situation 91 “pedestrian on walkway” addresses a pedestrian who is on a walkway along the road. The partial situation 92 “pedestrian at intersection” addresses a pedestrian in an intersection area. The partial situation 91 “pedestrian on walkway” is again specialized by the fourth partial situation 911 “pedestrian on walkway with zebra stripes”.

In general, the consideration of a larger context allows the derivation of more targeted boundary conditions since more knowledge about the overall situation is available and can be utilized in a corresponding partial situation. In the present example, the partial situation 9 “pedestrian”, which does not have any further context knowledge, would impose a certain safety distance between the EGO vehicle and the pedestrian as a boundary condition for the subsequent planning. On the other hand, if the pedestrian is on a potentially even structurally separated walkway, i.e., partial situation 91, this additional context may allow a smaller distance to the pedestrian since the pedestrian must not or cannot simply step onto the roadway if there is a walkway. This means that, due to the additional context of the partial situation 91 and the legal regulations applicable in this additional context, a less restrictive boundary condition may be used.

According to the present invention, this is utilized by using the information of the specialization hierarchy in the decomposition of the given situation into partial situations and in the instantiation of partial situations.

According to the present invention, the instantiation of the identified partial situations starts with the most specialized partial situations in the specialization hierarchy. These are partial situations that are not further specialized by any further partial situation of the specialization hierarchy. For each of these partial situations, it is checked whether they are applicable to the present situation and whether their stored instantiation conditions are fulfilled. If yes, the partial situation is instantiated and the objects addressed by this partial situation are marked as “addressed” in the object list of the environmental model.

Accordingly, in the present example, the partial situations 911 “pedestrian on walkway with zebra stripes” and 92 “pedestrian at intersection” are considered first. Both partial situations 911 and 92 are not applicable to the present traffic situation “pedestrian on a walkway without zebra stripes and outside an intersection area”.

Thereafter, the partial situations in which all the partial situations specializing them have already been checked are considered iteratively. Accordingly, in the second step, only the partial situation 91 “pedestrian on walkway” would be checked. In addition to checking the applicability to the current situation and the applicability of the instantiation conditions, it is now also checked whether the combination of the objects that would address this partial situation is already being addressed by a more specialized partial situation. If yes, no additional instance would be generated. If no, the partial situation would be instantiated accordingly and the addressed objects themselves would be marked as “addressed”. The partial situation 91 “pedestrian on walkway” is applicable to the present traffic situation “pedestrian on a walkway without zebra stripes and outside an intersection area” and the instantiation conditions are also fulfilled. In addition, neither the EGO vehicle nor the pedestrian is so far marked as “addressed” in the object list. Accordingly, the partial situation 91 is instantiated and the object list is updated by marking the EGO vehicle and the pedestrian as “addressed”.

In the third iteration step, the partial situation 9 “pedestrian” in the present example is now checked. Since both the EGO vehicle and the pedestrian have already been marked as “addressed” in the object list due to the instantiation of the partial situation 91 “pedestrian on walkway”, no additional instantiation of the partial situation 9 “pedestrian” is performed. As a result, it can be achieved that only the boundary conditions with the more specialized context are used in this situation.

An additional extension of the method described above is that a partial situation will remain relevant only for a certain period of time in the future within the planning horizon of the behavior planning or will only become relevant in the future. In this case, the marking “addressed” set by an instantiated partial situation would only apply for a certain time interval within the planning horizon. In this case, the more general partial situations would be instantiated for the time intervals that are not yet covered by the more specialized partial situations. However, the general procedure for instantiation does not change beyond that in comparison to the previously described procedure.

An example of such so-called contingency planning is described below:

A pedestrian walks on the walkway toward zebra stripes but is still so far away from the zebra stripes that the instantiation condition of the partial situation 911 “pedestrian on walkway with zebra stripes” is not yet met. However, the prediction for the pedestrian is that the pedestrian reaches the approach zone of the zebra stripes from a point in time t within the planning horizon Tₘₐₓ. In this case, the partial situation 911 “pedestrian on walkway at zebra stripes” would be used for the time interval [t, Tmax]. For the time interval [0, t), the partial situation 91 “pedestrian on walkway” would address the pedestrian. Since the complete time interval [0, Tmax] is thus covered, the pedestrian is considered “addressed” and the partial situation “pedestrian”is not instantiated any more.

The marking of the environment objects or participants in the traffic situation as “addressed” requires that tuples of traffic infrastructure elements, each matching the objects addressed by a partial situation, can always be marked as “addressed”. This may occur, for example, via sets of tuples or equivalent data structures. For the annotation of the time intervals, interval arithmetic is in particular suitable.

What is claimed is:

1. A computer-implemented method for planning a behavior of an at least partially automated EGO vehicle using a data basis of predefined partial situations and at least one evaluation model for each of the predefined partial situations, and a predefined set of rules for assessing possible behaviors of the EGO vehicle in a given situation, the method comprising the following steps carried out by the EGO vehicle:
aggregating situation-specific information;
generating an environmental model of the given situation based on the situation-specific information;
analyzing the environmental model to identify partial situations of the data basis;
generating instances for the identified partial situations using the situation-specific information;
analyzing all of the generated instances of the at least one instance by using the at least one evaluation model of the identified partial situations to determine boundary conditions for the possible behaviors of the EGO vehicle in the given situation; and
prioritizing the possible behaviors of the EGO vehicle based on the determined boundary conditions in conjunction with the set of rules;
wherein a specialization hierarchy for the partial situations of the data basis is provided, in that the partial situations identified as part of the analysis of the environmental model are successively instantiated, wherein an order of the identified partial situations is selected based on the specialization hierarchy, starting with at least one most specialized partial situation of the identified partial situations, and in that no further partial situation of the identified partial situations is instantiated at least when all objects of the given situation are already elements of a more specialized, already instantiated partial situation.

2. The method according to claim 1, wherein the specialization hierarchy of the partial situations is provided in a form of a tree structure or an acyclic graph.

3. The method according to claim 1, wherein the instances of the identified partial situations are generated for an entire planning horizon or only for a time segment of the planning horizon of the behavior planning.

4. The method according to claim 1, wherein each of the identified partial situations is defined as a situation class, which is at least partially determined by at least one of the following elements:
the EGO vehicle,
at least one traffic infrastructure element,
at least one further road user, and
a general situation context,
wherein the EGO vehicle and the at least one further road user represent the objects of the given situation, and each of the identified partial situations is instantiable by populating with situation-specific information.

5. The method according to claim 1, wherein the predefined partial situations of the data basis are selected such that an environmental model generated based on situation-specific information can be represented by a composition of certain predefined instantiated partial situations of the data basis.

6. The method according to claim 1, wherein at least a portion of the evaluation models is based on decomposing a respective partial situation into zone graphs and on morphologically analyzing a behavior of an involved road users.

7. The method according to claim 1, wherein at least a portion of the evaluation models includes combination rules for a combination of a respective partial situation with further partial situations.

8. The method according to claim 1, wherein the predefined set of rules includes and prioritizes: (i) safety requirements and/or (ii) traffic rules and/or (iii) comfort requirements and/or (iv) technical vehicle boundary conditions.

9. The method according to claim 1, wherein each individual one of the generated instances is analyzed separately in order to generate instance boundary conditions for the possible behaviors of the EGO vehicle for the individual instance, wherein the at least one evaluation model and the situation context of the individual partial situation are used for the analysis.

10. The method according to claim 9, wherein the boundary conditions for the possible behaviors of the EGO vehicle in the given situation are determined by combining at least a portion of the generated instance boundary conditions, taking into account combination rules of the respective evaluation models.

11. The method according to claim 1, wherein the determined boundary conditions for the possible behaviors of the EGO vehicle are compared with the rules of the set of rules, and the possible behaviors of the EGO vehicle are prioritized based on the comparison.

12. The method according to claim 11, wherein the comparison of the boundary conditions for the possible behaviors of the EGO vehicle with the rules of the set of rules is logged.

13. The method according to claim 1, wherein at least one of the possible behaviors of the EGO vehicle in the given situation is defined by:
at least a portion of the determined boundary conditions, or
a set of behavior instructions that implement at least a portion of the determined boundary conditions, or
a reference trajectory that fulfills at least a portion of the determined boundary conditions.

14. The method according to claim 1, wherein a possible behavior of the EGO vehicle to be implemented in the given situation is not detailed and/or optimized with respect to a specified quality function until after the prioritization of the determined possible behaviors.

15. The method according to claim 1, wherein the boundary conditions for the possible behaviors of the EGO vehicle are used as filters for present trajectory candidates to eliminate trajectory candidates that are not compatible with the boundary conditions.

16. A computer-implemented system for planning a behavior of an at least partially automated EGO vehicle, the system comprising:
a data basis of predefined partial situations, a specialization hierarchy for the partial situations, and at least one evaluation model for each of these partial situations;
a perception module configured to aggregate situation-specific information;
an evaluation module configured to generate an environmental model based on the situation-specific information;
a decomposition module configured to:
(i) identify partial situations of the data basis in the given situation by analyzing the environmental model, and
(ii) successively generate instances for each respective partial situation of the identified partial situations using the situation-specific information, wherein an order of the identified partial situations is selected based on specialization hierarchy, starting with the at least one most specialized partial situation, and no further partial situation of the identified partial situations is instantiated at least when all objects of the given situation are already elements of a more specialized, already instantiated partial situation;
an analysis module configured to determine boundary conditions for possible behaviors of the EGO vehicle in the given situation by analyzing all generated instances by using the at least one evaluation model of the respective identified partial situation; and
a predefined set of rules for assessing and prioritizing the possible behaviors based on the determined boundary conditions.
